(19) United States
(12) Patent Application Publication
(10) Pub. No.: US 2005/0236195 A1
(43) Pub. Date: Oct. 27, 2005

(54) Telescopic loader, in particular a reach stacker

(76) Inventor: Walter Mietschnig, Brand (AT)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/107,638

(22) Filed: Apr. 14, 2005

(30) Foreign Application Priority Data
Apr. 16, 2004 (DE) 10 2004 018 645.6

(51) Int. Cl. B60K 8/00

(52) U.S. Cl. 180/54.1

(57) ABSTRACT

The application relates to a telescopic loader, in particular a reach stacker, consisting of a vehicle frame, wheels arranged thereon and a telescopic boom pivotably arranged thereon with a load receiving means for the transferring of heavy loads such as containers, trailers, sheet metal coils, part loads and the like. In one example, respective individual wheel hubs with an integrated planetary gear and a hydrostatic drive are provided for the driven wheels.

### CROSS-REFERENCE TO RELATED APPLICATION

This application claims priority to German Applicatin Serial No. 102004018645.6 filed Apr. 16, 2004, the entire disclosure of which is hereby incorporated by reference into the present application, as provided in MPEP § 201.13.

### BACKGROUND AND SUMMARY

The present application relates to a telescopic loader, in particular a reach stacker, comprising a vehicle frame, wheels arranged thereon and a telescopic boom pivotably arranged thereon with a load receiving means for the transferring of heavy loads such as containers, trailers, sheet metal coils, part loads and the like.

Reach stackers are vehicles with rubber tires, fitted with a diesel engine and an operator's cabin, similar to a retracted mobile crane. They can transport and stack containers. The previously known reach stackers are designed with a container spreader fixedly connected to the telescopic arm, i.e. the spreader raising movement is only carried out via the telescopic arm. In known reach stackers, the operator's cabin is arranged fixedly or movably on the frame in the rear part on the vehicle, which always permits a good view for the operator of the container spreader fixedly connected to the telescopic arm with the current design.

Up to now, with known telescopic loaders such as the aforesaid reach stacker, a rigid, non-steerable drive axle was used due to the high axle loads which occur. The drive axle was fitted with differential gears and planetary gears arranged centrally or slightly eccentrically in the wheel hubs. These differential gears were driven either mechanically via propeller shafts or hydrostatically with or without intermediate gearboxes via hydraulic motors. In known telescopic loaders, service braking takes place via dry or wet-running multi-plate brakes which are installed in the wheel hubs. The holding brake as a rule consists of a spring-loaded disk brake which is either mounted to the differential, or the propeller shaft or the intermediate gearbox.

In known reach stackers, a non-driven, steerable axle is used as the steering axle which consists of an axle housing, rotatable steering knuckles and track rods. A floating bearing, a so-called 3-point bearing for the steering axle, is predominantly used to compensate for uneven driving surfaces. The wheels arranged at the steering axles are fitted with, and partly without, a service brake or holding brake. The steering is carried out via one or more hydraulically actuated steering cylinders.

In the known design of a telescopic loader, predominantly a reach stacker such as was described above, there is the disadvantage of a high tire wear in the steering axle which in particular arises on pronounced steering movements as a consequence of the central drive and the inner friction in the differential gear. A differential lock is moreover required for the transfer of the drive power to the ground if one side of the driving axle is located on a slippery, smooth surface. Only conventional steering is possible with the known telescopic loaders due to the previously described axle support. Transverse driving, i.e. driving 90% with respect to the vehicle frame, and slanted driving, the so-called “dog gait”, are not possible. Only a limited maneuverability of the telescopic loader, i.e. in particular of the reach stacker, is hereby given. Moreover, due to the rigid axle arrangement, no height compensation is possible when driving on a sloped plane.

It is the object of the invention to further develop telescopic loaders, in particular reach stackers, such that in particular the high tire wear is reduced and/or the maneuverability of the telescopic loader is improved.

In one example embodiment, the object is solved by a telescopic loader, for example a reach stacker, comprising a vehicle frame, wheels arranged thereon and a telescopic boom pivotably arranged thereon with a load receiving means for the transferring of heavy loads, where respective individual wheel hubs with an integrated planetary gear and a hydrostatic drive are provided for the driven wheels. Note that various types of telescopic loaders may be used, such as, for example, a reach stacker. Also, the heavy loads may include various items, such as containers, trailers, sheet metal coils, part loads and the like.

Accordingly, a telescopic loader is further developed in that respective individual wheel hubs with integrated planetary gears and hydrostatic drives are provided for the driven wheels. Every driving wheel or every wheel pair can be controlled individually due to this solution. It is thereby possible to supply different drive powers to the respective drive wheels and thereby to build up a steering torque which supports the steering movement. The lateral forces in the steering wheels can hereby be substantially—or almost completely—reduced. One advantage is the reduced strain on the steering wheels and thus the increased running performance of the wheels. Furthermore, traction is also increased on a slippery, smooth driving surface due to this single-wheel drive, since the wheels can be individually supplied with a maximum possible drive torque depending on the traction present. An anti-slip control for each individual wheel already known from the prior art is possible here.

Additional features may also be used to obtain still further advantages, as described below.

For example, the driven wheels can be hydraulically suspended. This hydraulic suspension can take place without a floating bearing. It can, however, also be designed such that it is combined with a floating bearing.

Slanting vehicle positions can hereby be compensated via the individual cylinders.

The vehicle can advantageously be driven with a statically determined 3-point support in that the floating axle is imitated by a connection of left and right compensation cylinders.

A switch to four-point support can be made at any time to increase the lateral stability. For this purpose, the connection of the left and right compensation cylinders is separated.

To be able to carry higher loads, the vehicle can be operated with any desired number of wheelset groups which can be connected in accordance with a desired three-point support or four-point support.

The individual wheel drive can also be fitted with pivot devices. Any possible maneuver version is hereby made possible, in particular when all wheels or wheel pairs are driven individually. In addition to the conventional curve driving, a diagonal, slanting driving, the so-called “dog gait”, is possible. A transverse driving, that is driving of 90% with respect to the vehicle frame, is possible, if desired. Finally, the telescopic loader can also be rotated in a standing position. The positioning of the load is substantially facilitated due to this improved maneuverability.

Further features, details and advantages result from the embodiments shown in the drawing and described in the specification.

### BRIEF DESCRIPTION OF THE FIGURES

FIG. 1 is a schematic view of a first embodiment;

FIG. 2 is a schematic view of an alternative embodiment;

FIG. 3 is a schematic representation of a further alternative in an aspect;

FIG. 4 is a schematic representation of the wheel load of telescopic loaders of the prior art without an individual wheel drive;

FIG. 5 is a representation in accordance with FIG. 4 with an individual wheel drive; and

FIG. 6 is a schematic representation of different steering possibilities of the wheels of a telescopic loader.

### DETAILED DESCRIPTION

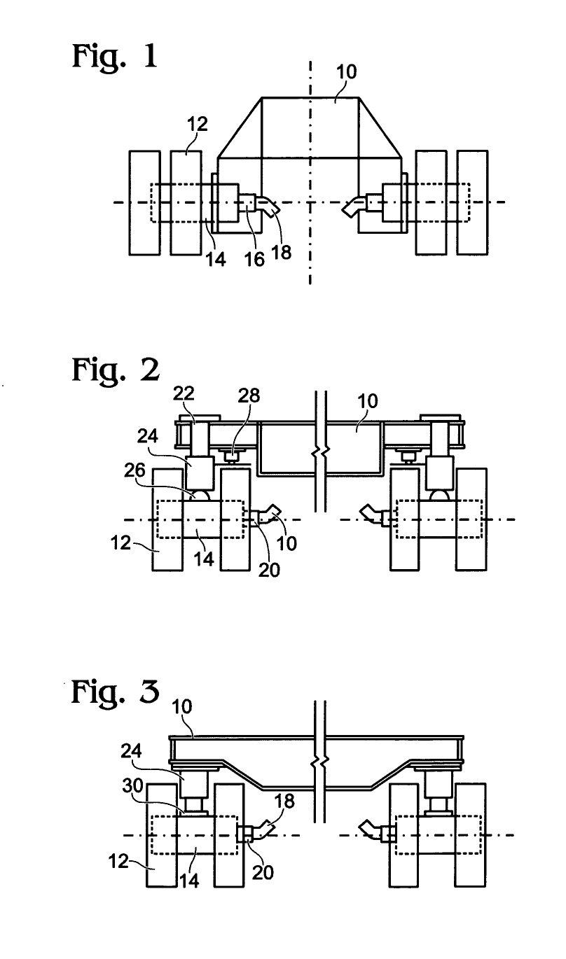

In the schematic representation in accordance with FIG. 1, a vehicle frame 10 on which two respective wheel pairs 12 are carried via a corresponding axle bearing is shown of the telescopic loader, for example a reach stacker. An individual wheel hub 14 with a planetary gear is associated with each wheel pair. Parking brakes 16 are associated with the respective individual wheel hubs with planetary gear. The respective wheel hub pairs 12 can be driven individually via hydraulic motors 18 associated with these.

In the representation in accordance with FIG. 2, a respective hydraulically suspended individual wheel drive with pivot devices is arranged on the vehicle frame 10. In the same manner as in the embodiment in accordance with FIG. 1, the double wheels 12 each have hydraulic motors 18 for their driving, individual wheel planetary gears 14 and respectively associated parking brakes 20. The respective individual wheel drive is hydraulically suspended via a compensation piston-in-cylinder pair 22, 24. The wheel pair 12 is floatingly connected to the compensation cylinder 24 via a floating bearing 26. A steering of the driven wheel pairs 12 takes place by a pivot drive 28 which is shown schematically in FIG. 2 and which is likewise hydraulically driven.

In FIG. 3, a hydraulic suspension of the wheel pair 12 corresponding to that of FIG. 2 is shown, with the same parts again being called the same here. Here, however, a rigid bearing of the wheel pairs 30 is present instead of a floating bearing 6.

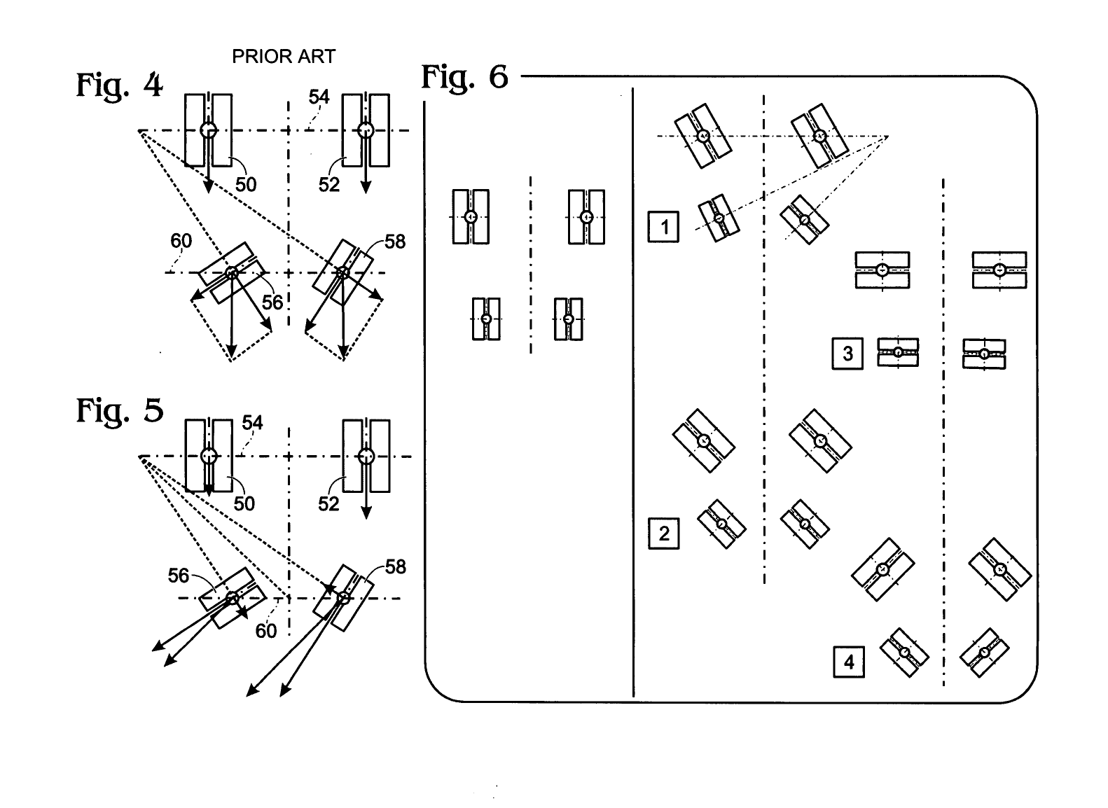

In FIG. 4, the driving load of a telescopic loader undercarriage of conventional design, that is without an individual wheel drive, is shown. The wheel pairs 50 and 52 of the rigid axle 54 are shown here. The wheel pairs 50 and 52 are centrally driven in accordance with the prior art. The deflected wheel pairs 56 and 58 of the steering axle 60 are deflected in accordance with the prior art as is shown in FIG. 4 via a steering knuckle steering system not shown in more detail here. The reaction forces drawn in accordance with the force parallelogram which lead to a comparatively high wear of the double wheels result here.

In FIG. 5, the comparative situation of the respective double wheels provided with individual wheel drive is shown. It is shown with reference to the force arrows that individually different drive powers can be set for each wheel so that the force parallelograms resulting for the steered wheels 56 and 58 are more favorable, with a lower wear of the steered wheel pairs 56 and 58 occurring due to the better force distribution. FIG. 6 shows the advantageous steering possibility of telescopic loaders which are provided with hydraulically suspended single wheel drive with pivot devices. Straight-line driving is shown in the left hand part of the representation. Representations 1, 2, 3 and 4 in FIG. 6 show different steering movements of the individually pivotable, i.e. steerable, wheel pairs. Under number 1, a steering movement for a conventional curve driving is shown, with a very small steering circle being able to be described here. FIG. 2 shows the steering movement for a diagonal, slanting driving of the telescopic loader, the so-called dog gait.

FIG. 3 shows the possibility of transverse driving, i.e. driving by 90% with respect to the vehicle frame.

FIG. 4 shows a steering movement in which the vehicle can be rotated in a standing position. An optimum positionability of loads by means of the correspondingly steerable telescopic loader results overall.

1. A telescopic loader, comprising a vehicle frame, wheels arranged thereon and a telescopic boom pivotably arranged thereon with a load receiving means for the transferring of heavy loads, where respective individual wheel hubs with an integrated planetary gear and a hydrostatic drive are provided for the driven wheels.

2. A telescopic loader in accordance with claim 1, wherein the driven wheels are hydraulically suspended.

3. A telescopic loader in accordance with claim 2, wherein the hydraulic suspension of the driven wheels is combined with a floating bearing.

4. A telescopic loader in accordance with claim 2, wherein a floating axle can be imitated by the connection of left and right compensation cylinders to drive the telescopic loader with a statically defined 3-point support.

5. A telescopic loader in accordance with claim 2, wherein the loader can be switched from a three-point support to a four-point support.

6. A telescopic loader in accordance with claim 1, wherein the individual wheel drive is fitted with pivot devices.

7. A telescopic loader in accordance with claim 1, wherein all wheels or wheel pairs are driven individually.

8. A telescopic loader in accordance with claim 1 wherein said telescopic loader includes a reach stacker.

9. A telescopic loader in accordance with claim 1 wherein said load includes at least one of containers, trailers, sheet metal coils, and part loads.

10. A telescopic loader, comprising a vehicle frame, wheels arranged thereon and a telescopic boom pivotably arranged thereon with a load receiving means for the transferring of heavy loads, where respective individual wheel hubs with an integrated planetary gear and a hydrostatic drive are provided for the driven wheels so that every driving wheel or every wheel pair can be individually controlled.

11. A telescopic loader in accordance with claim 10 wherein said load includes at least one of containers, trailers, sheet metal coils, and part loads.

12. A telescopic loader in accordance with claim 11 wherein different drive powers are supplied to the respective drive wheels to build a steering torque which supports the steering movement.

13. A telescopic loader in accordance with claim 12 wherein lateral forces in steering wheels can hereby substantially reduced.

14. A telescopic loader in accordance with claim 13 wherein the wheels are individually supplied with a maximum possible drive torque depending on available traction.

15. A telescopic loader in accordance with claim 10 further comprising anti-slip control for each individual wheel.

16. A telescopic loader, comprising:
a vehicle frame;
driven wheels arranged thereon having respective individual wheel hubs with an integrated planetary gear means and a hydrostatic drive means for individually controlling drive torque to every driving wheel or every wheel pair; and
a telescopic boom pivotably arranged thereon with a load receiving means for the transferring of heavy loads.
